(19) United States
(12) Patent Application Publication
(10) Pub. No.: US 2007/0276647 A1
(43) Pub. Date: Nov. 29, 2007

(54) Simulation Method and Tool

(76) Inventors: Keith Cullen, Dublin (IE); Neil Hurley, Co. Meath (IE); Guenole Silvestre, Dublin (IE)

Correspondence Address: NATH & ASSOCIATES, 112 South West Street, Alexandria, VA, 22314, US

(21) Appl. No.: 11/667,009

(22) PCT Filed: Oct. 27, 2005
(86) PCT No.: PCT/EP05/11630

§ 371 Date: May 4, 2007

(30) Foreign Application Priority Data
Nov. 5, 2004 (IE) S2004/-744

(51) Int. Cl. G06F 9/45

(52) U.S. Cl. 703/22

(57) ABSTRACT

A method for optimising application program code including a plurality of fixed point variables. Each fixed point variable comprises a binary pattern. The binary pattern has an integer portion having an integer word length (IWL) and a fractional portion having a fractional word length (FWL). The method comprises simulating execution of the application to identify any variables to which values having a greater IWL are assigned and modifying the code to increase the IWL of those variables by an amount required to prevent overflow errors.

The present invention relates to a simulation method and tool for optimising software including fixed point variables.

Floating point and fixed point refer to numbering systems in computer arithmetic and the operations defined on them.

Floating Point is a representation of real (fractional) numbers. Floating point numbers have two parts: the mantissa; and an exponent which is used to keep track of how the binary point is shifted. Floating point format automatically scales all numbers by moving, and keeping track of the binary point so that all numbers use the full word length available but never overflow.

Floating point arithmetic offers superior numerical accuracy by dynamically adjusting the range and precision of each variable to give the most accurate representation of any assigned value. However, the complexity of the digital logic and the time required to carry out operations is a distinct disadvantage.

An arbitrary word length (AWL) fixed point variable comprises a binary pattern and an implied binary point. There are up to three parameters associated with each variable. Word Length (wl) is the total number of bits in the binary pattern; Integer Word Length (iwl) is the number of bits to the left of the binary point not including the sign bit; and Fractional Word Length (fwl) is the number of bits to the right of the binary point.

Fixed point arithmetic can be implemented using much simpler and faster logic circuits on platforms such as microprocessors, digital signal processors (DSP) or Field Programmable Gate Arrays (FGPA), but once defined, the range and precision of each variable remains constant. In particular, a designer has to calibrate each variable to attain a good compromise for all values that are expected in practice. For example, many operations (*, /, +, − . . . ) on fixed point variables require both operands to have the binary point located in the same place. If this is not the case then one of the operands must be shifted—this is referred to in the present specification as an “alignment shift”. This process usually involves right shifting the variable with the larger fractional word length, FWL. The consequence is that least significant bits (LSBs) are lost from this variable before the operation begins and as such accuracy deteriorates. Also, in order to assign one fixed point variable to another the binary point of the source operand must be lined up with that of the destination operand—referred to herein as an “assignment shift”. This may involve a left shift, which runs the risk of an overflow error or a right shift in which LSBs from the source operand are lost.

System C (www.systemc.org) provide a simulation system with arbitrary precision fixed point C++ classes which are ported from an existing application by changing floating point to fixed point variable definitions. The tool allows bit exact simulation of any target platform with unrestricted parameter values. However the application may have to be executed and manually adjusted many times in order to eliminate, for example, overflow errors and to optimise resolution.

It is an object of the present invention to mitigate one or more of the disadvantages of the prior art.

According to the present invention, there is provided a method according to claim 1.

In a further aspect of the invention there is provided a simulation tool arranged to perform the steps of the above method.

Using preferred embodiments of the invention, for a given piece of application program code, the components of all fixed point variables involved can be optimised with minimum loss of precision and also the number of shift operations needed to align and assign fixed point variables may also be minimised.

The preferred embodiment is based on the observation that if unused LSBs and zero filled LSBs for each fixed point variable in an application are zero, then the number of scaling operations needed for execution of that application is minimised. This is due to the reduction in the required number of alignment and/or assignment shift operations.

Embodiments of the invention will now be described, by way of example, with reference to the accompanying drawings, in which:

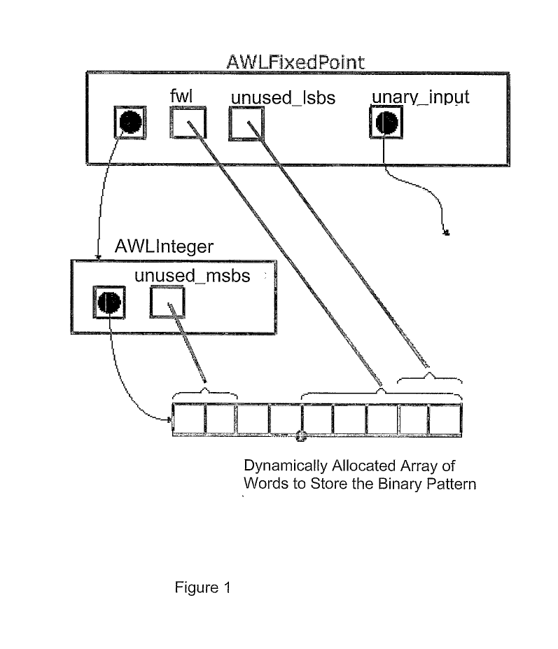

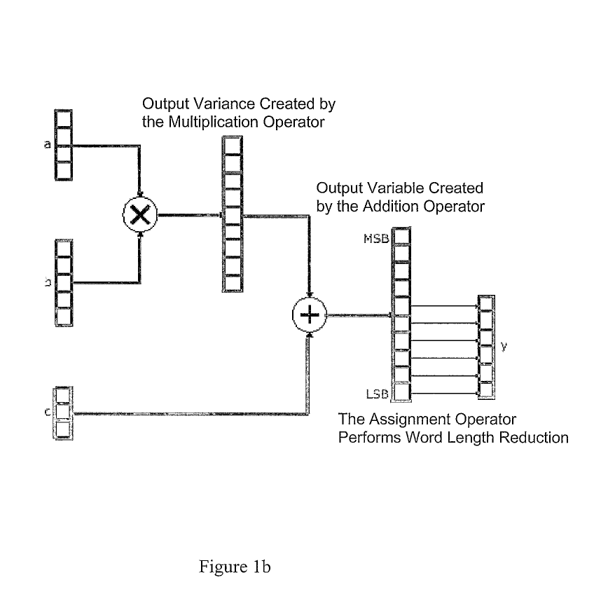

FIG. 1 shows the member variables of an AWLFixedPoint object used by a simulation tool according to a first embodiment of the present invention;

FIGS. 1B and 1C show the components involved in the processing of a respective fixed point variable operations;

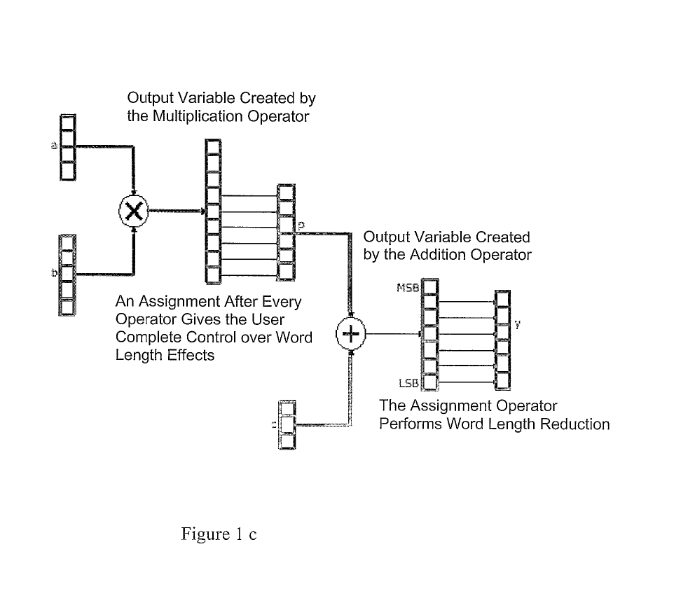

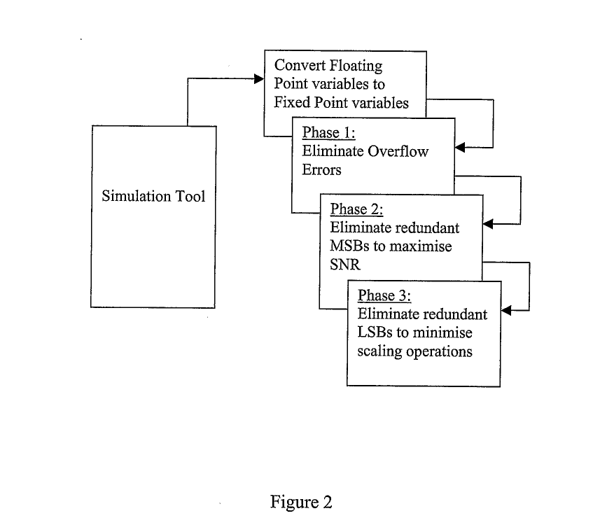

FIG. 2 shows the processing phases performed by the simulation tool according to a first embodiment of the present invention;

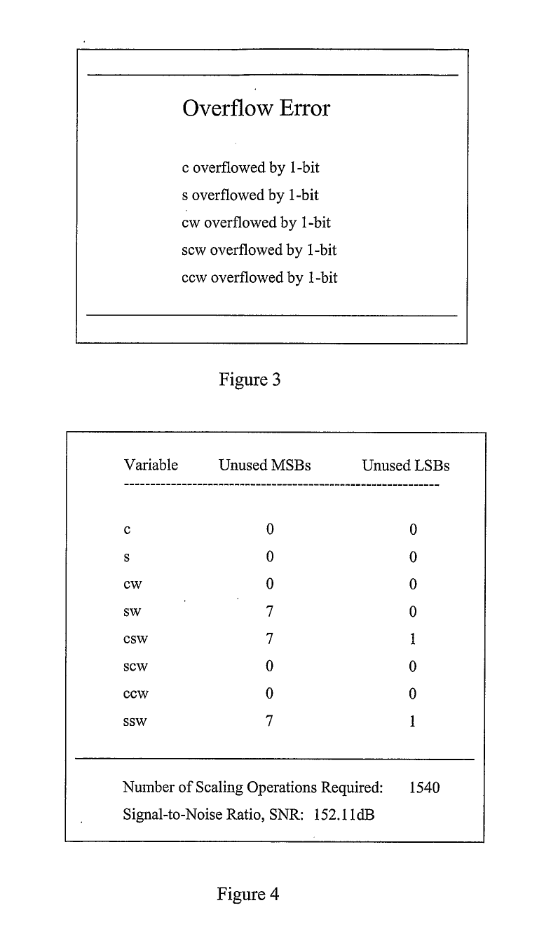

FIG. 3 illustrates the overflow information produced during phase 1 of the processing of FIG. 152; and

FIG. 4 illustrates the redundant MSB and redundant LSB information produced after phase 1 of the processing of FIG. 2;

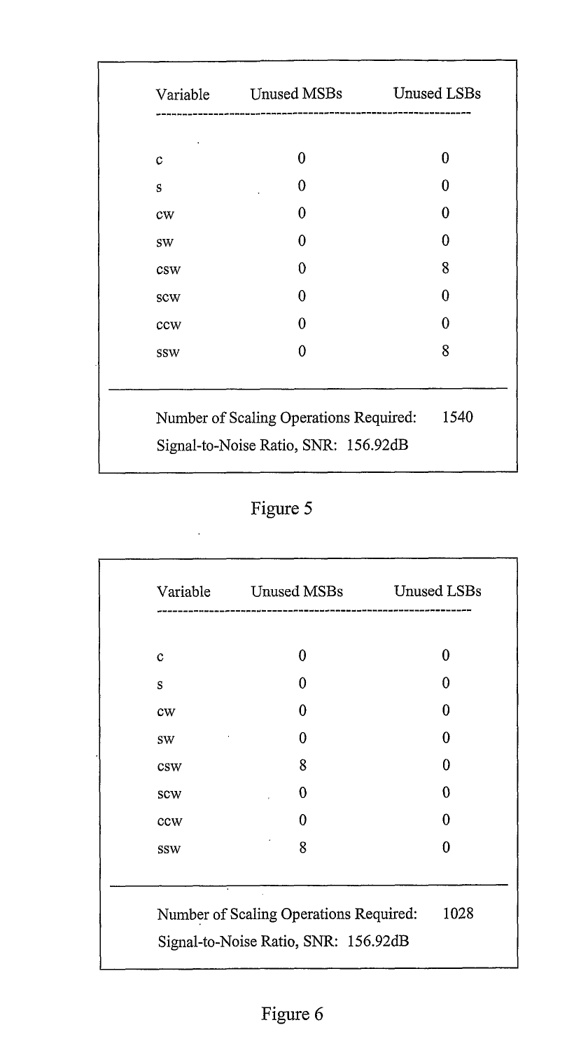

FIG. 5 illustrates the redundant MSB and redundant LSB information produced during phase 2 of the processing of FIG. 2;

FIG. 6 illustrates the redundant MSB and redundant LSB information produced during phase 3 of the processing of FIG. 2;

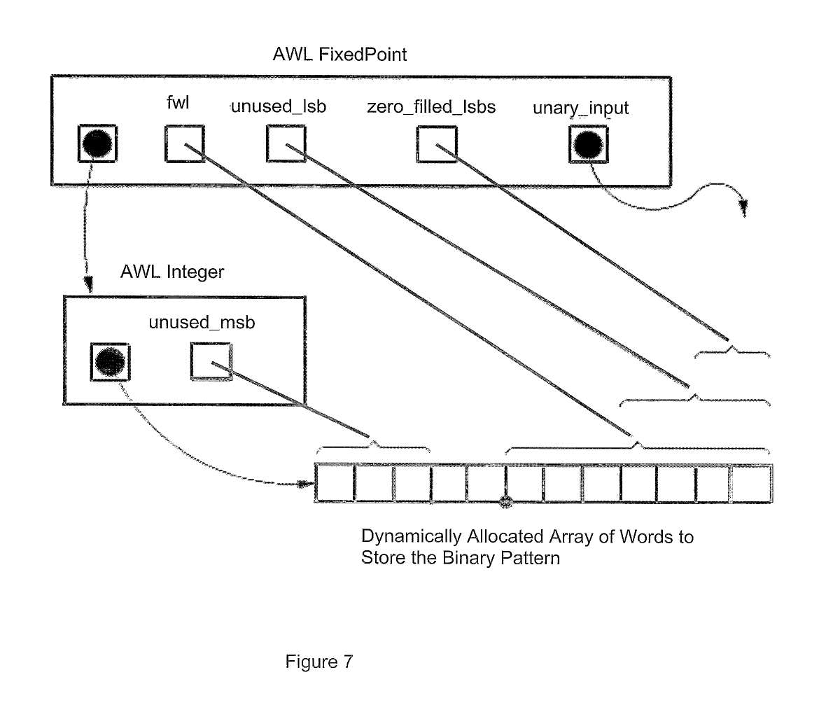

FIG. 7 shows the member variables of an AWLFixedPoint object used by a simulation tool according to a preferred embodiment of the present invention;

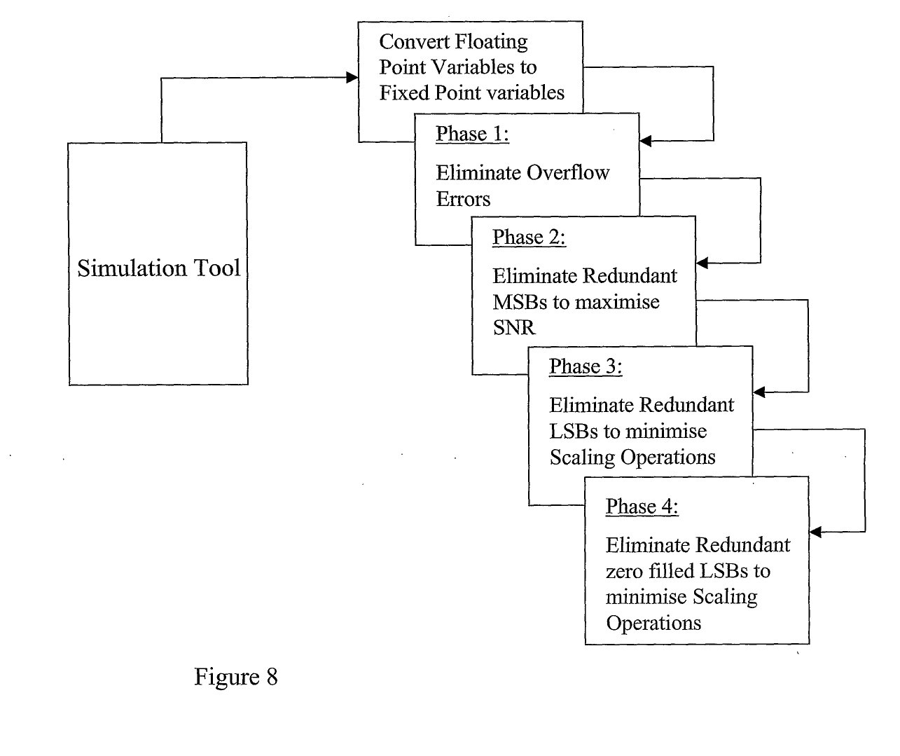

FIG. 8 shows the processing phases performed by the simulation tool according to the preferred embodiment of the present invention;

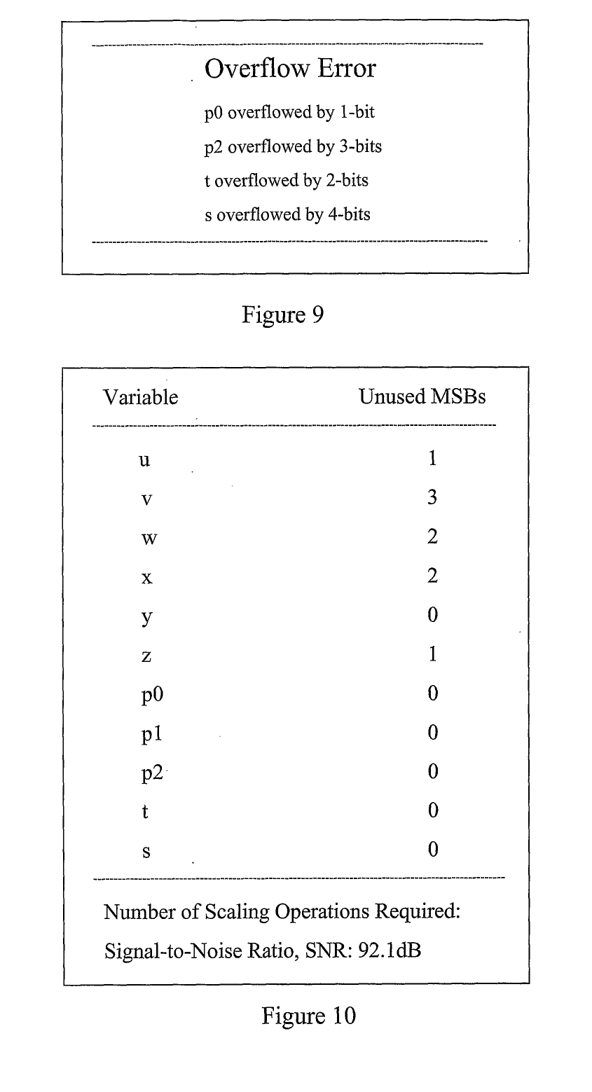

FIG. 9 illustrates the overflow information produced during phase 1 of the processing of FIG. 8; and

FIG. 10 illustrates the redundant MSB information produced after phase 1 of the processing of FIG. 8;

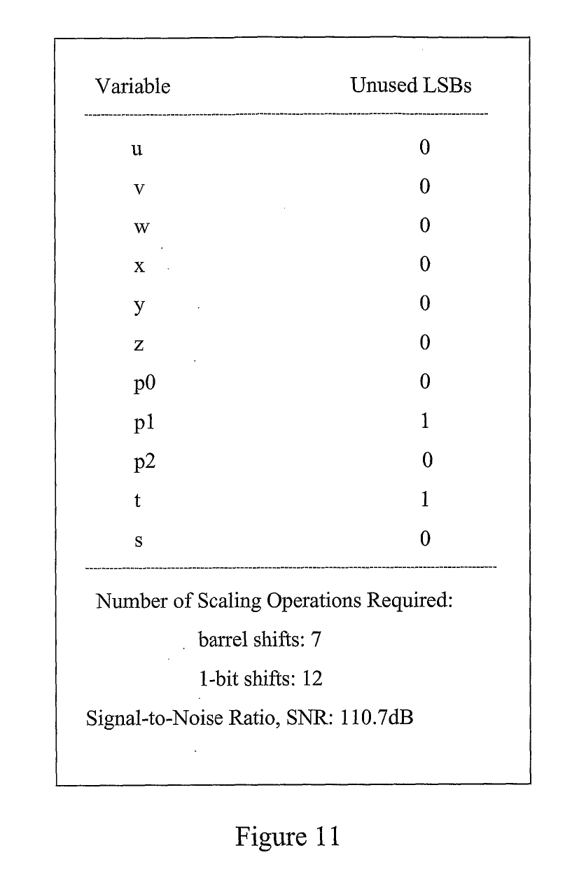

FIG. 11 illustrates the redundant LSB information produced during phase 2 of the processing of FIG. 8; and

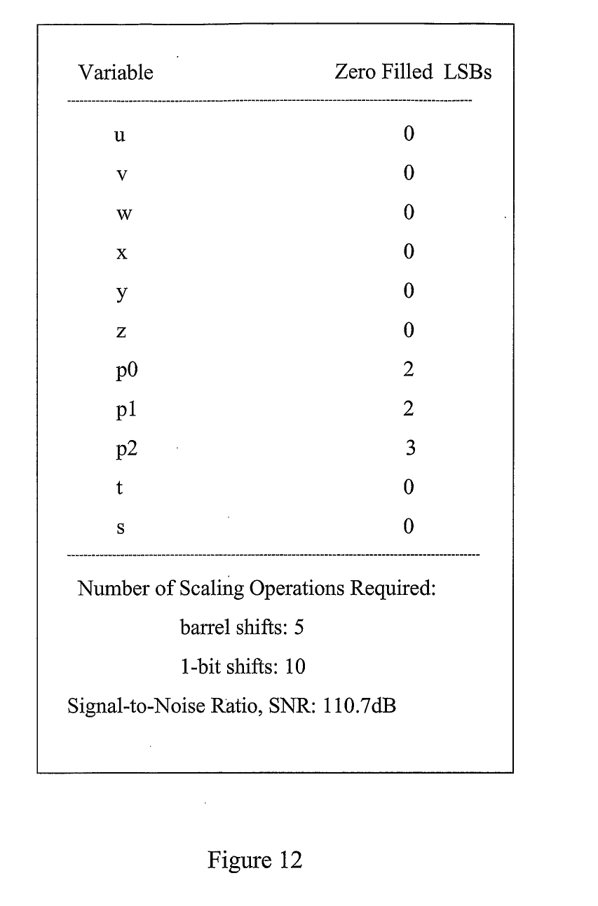

FIG. 12 illustrates the redundant zero filled LSB information produced during phase 3 of the processing of FIG. 8.

According to the embodiments of the present invention described herein, there is provided a simulation tool generally of the type described above in that program code for an application can be compiled and executed using the tool. In the prior simulation tool, fixed point variables are instances of a class comprising an integer component having a length IWL and a fractional component having a length FWL. The combined length (WL) of the integer and fractional components is usually determined globally according to the platform on which the application will ultimately be deployed and so in practice only knowledge of one of IWL or FWL is required to determine the location of the binary point for a variable.

In a first embodiment, the tool includes a class comprising two abstract data types, AWLInteger and AWLFixedPoint, FIG. 1. In the embodiment, these data types are arranged to identify the number of redundant bits in a fixed point variable binary pattern.

The AWLInteger class uses an array of words to represent a binary pattern of any size. Each AWLInteger object comprises a pointer to the address in dynamic memory where the binary pattern is stored. Each AWLInteger object further comprise a member variable, unused MSB, that keeps track of the maximum highest order non-redundant bit of all values assigned to it and indicates the number of unused most significant bits (MSBs) for that object. The number of MSBs for that object can be negative, indicating the occurrence of overflow errors, or positive, indicating redundant bits. This measurement is dependent on the values that are assigned to an object. If these values are not representative of all values expected in practice, then reducing word length based on this measurement may lead to overflow errors.

In this embodiment, each object also includes a string (not shown) that can be user defined to label that object. This is useful when specific information on a particular variable such as the occurrence of overflow errors is reported to the user.

The AWLFixedPoint class is derived from the AWLInteger class as illustrated in FIG. 1. In the preferred embodiment, each AWLFixedPoint object points to an AWLInteger object in turn pointing to the binary pattern. AWLFixedPoint also includes an FWL variable to define the binary point location.

The AWLFixedPoint class further comprises a member variable, unused LSBs, to record the unused least significant bits (LSBs) in each object.

In the preferred embodiment, the AWLFixedPoint class used further comprises zero filled 1 sbs to record the number of 1 sbs in each object that are always set to zero, as illustrated in FIG. 7.

As will be explained later, these values are not dependent on the particular values assigned to an object but on the operations performed on it.

The AWLFixedPoint class also comprises a unary input pointer which points from an implicit fixed point variable to a corresponding explicit variable as will be explained in more detail below.

During an assignment operation a source object and a destination object may have different integer word lengths. If the destination object has the higher integer word length this results in redundant bits. If however the source object has the higher word length, the MSBs from the source object are lost and overflow is possible.

Referring now to FIG. 1B, there is depicted a schematic view of how a simple expression y=a*b+c is typically evaluated. In this example, an implicit variable created to store the result of the multiplication operation is used as an input to the addition operator. According to the preferred embodiment, in order that a user may maintain complete control over all word lengths in an algorithm, each implicit variable must be assigned to an explicit variable. This is achieved by breaking up expressions involving more than one operator into a number of sub-expressions involving only one operator as is illustrated in FIG. 1c. In this case, the expression y=a*b+c is replaced with two expressions, p=a*b and y=p+c. The new variable p stores the output of the multiplication operator. Thus redundant MSBs associated with a particular variable can be identified to the user enabling them to constrain the integer word length at this point in the algorithm. Similarly, the occurrence of overflow errors associated with a particular variable can be indicated to the user.

Considering now the effect of operations on the FWL of a variable. During execution of a program, fixed point variables are generally written once and read many times.

A fixed point variable can be read by an assignment, a unary operator (|x|, −x), a binary operator that involves alignment (+,−) or a binary operator (*,/) that doesn't involve alignment. If the operator involves alignment, the read operations may include a right shift. In the first three cases there is a possibility that some of the LSBs in an input operand not be read as they may be mapped on to a variable having less precision.

A write operation (assignment) can include a left or right assignment shift on a source object. The read operations may include a right shift if the operator involves alignment. The shift amounts depend on the FWL of the source objects. If a variable has a non-zero value of unused LSBs, then the assignment shift can always be changed to eliminate one of the alignment right shifts.

Consider the following examples, where the subscript bin refers to an entire fixed point variable binary pattern; the subscript f refers to the fractional word length of the variable; and the symbols >> and << indicate right and left shifting of a binary pattern respectively.

An assignment to a fixed point variable x involves a left shift on the source variable, a, by 8 bits. X is read by the addition and subtraction operations and aligned using right shifts of 4 bits and 2 bits respectively.
X_{bin}=a_{bin}<<8
Y_{bin}=(x_{bin}>>4)+b_{bin}
Z_{bin}=(x_{bins}>>2)−c_{bin}

In this example, if all shift operations are altered by adding a right shift amount of 2 bits, then the smallest right shift can be eliminated to give;
X′_{bin}=a_{bin}<<6
Y_{bin}=(x′v>>2)+b_{bin}
Z_{bin}=x′_{bin}−c_{bin}

This is achieved by reducing the fwl of x by 2 bits.

If the assignment involves a right shift instead of a left shift, then one of the alignment shifts can be eliminated in the same way.

However in some cases when the assignment shift is zero, an assignment shift can be added and an alignment shift removed so the number of operations before and after optimisation is the same. This has no negative effect and so doesn't have to be avoided.

For example, consider the following case.
X_{bin}=a_{bin}
Y_{bin}=(x_{bin}>>2)+b_{bin}
Z_{bin}=(x_{bin}>>1)−c_{bin}

After optimisation, it can be seen that the net number of operations is the same and the numerical accuracy has not been affected.
X′_{bin}=a_{bin}>>1
Y_{bin}=(x_{bin}>>1)+b_{bin}
Z_{bin}=x_{bin}−c_{bin}

Considering the case in which two variables are read by a binary operation that doesn't involve alignment (*, /). No reduction in FWL is possible for either operand so there is no risk that optimising one variable will have any effect on the other. A reduction in FWL for the destination variable doesn't allow any further reduction in FWL for either input variable. This is because for multiplication and division the output is dependent on all bits from both inputs. In other words removing LSBs from the output doesn't allow LSB from the inputs to be removed. Thus, in the preferred embodiment of the invention, the simulation tool is not arranged to track the affect of such binary operators on unused MSBs or LSBs. Nonetheless, it will be appreciated that if the result of such an operation is assigned, the affect of the assignment operator on unused MSBs or LSBs is tracked.

If two variables are read by a binary operation that does involve alignment (+, −, ==, !=, <, ≦, >, ≧), then due to the nature of alignment only one can have an non-zero value of unused LSB. The other variable cannot be optimised so there is no dependency between the two inputs. For addition and subtraction the output is dependent on all bits from both inputs, so as with multiplication and division a reduction in FWL for the destination variable doesn't allow any further optimisation of either input. The other operators (==, !=, <, ≦, >, ≧) are relational and return a true or false value. As such no dependency exists between the inputs and the destination variable and optimisation can be achieved as shown above.

If one variable is directly assigned to another, then the assignment may involve a left shift, no shift or a right shift as shown below.

Assignment to x with no shift:

Before x is optimised: X_{bin}=y_{bin}

After x is optimised: x′_{bin}=[y_{bin}]>>(x_{f}−x′_{f})

Assignment to x with left shift:

Before x is optimised: x_{bin}=y_{bin}<<(x_{f}−y_{f})

After x is optimised: x′_{bin}=[y_{bin}<<(x_{f}−y_{f})]>>(x_{f}−x′_{f})

Assignment to x with right shift:

Before x is optimised: x_{bin}=y_{bin}>>(x_{f}−y_{f})

After x is optimised: x′_{bin}=[y_{bin}>>(x_{f}−y_{f})]>>(x_{f}−x′_{f})

In each case optimising x adds a right shift amount to the assignment resulting in fewer LSBs from the source operand y being read during the assignment to the new destination variable x′. Thus there is a possibility that following a reduction in x_{f}, there can be an increase in the unused LSB of y and as such the unused LSBs of y should be measured again. This dependency means that optimisation of all variables may not be possible in one attempt and so in the preferred embodiment optimisation of the program code is performed over several phases.

However, unused LSBs are dependent only on the operations involved in the algorithm and not the actual values of the variables. As such, in the preferred embodiment, when measuring unused LSBs the optimisation procedure requires only one pass over the application program code including only one pass of each loop. This can be achieved either by altering the program code to ensure each loop only has one iteration, or the simulation tool itself can be arranged only to iterate once over each loop.

For all unary operators (|x|, −x, x, x>>c) the output is given the same WL and FWL as the input. There is a dependency between the unused LSB of the input and the output. This is not obvious because for any unary operator all bits are read from the input so it would seem that its unused LSB must be zero. If however the output variable has a non-zero value of unused LSB then the input variable can also have a non-zero value of unused LSB.

This dependency means that information must be shared between two AWLFixedPoint objects that are linked by a unary operator. The output of the operator is an implicit variable and of no interest in terms of optimisation. The input is an explicit variable and the information on read operations should be passed from the output variable to the input. If the input to a unary operator is to be optimised, then it must have unused LSB information from the output of that operator. Thus, a link between the two objects is established using the unary pointer from output to input, as mentioned earlier.

According to the preferred embodiment, a further optimisation step reduces shift amounts in assignment operations.

The following example describes an addition operation. Optimisation is only possible if the adder inputs do not need to be aligned. The values a and b which are the results of previous operations are written to the variables x and y. x and y are then used as inputs to an addition operator.
x_{bin}=a_{bin}<<3
y_{bin}=b_{bin}<<2
z_{bin}=(x_{bin}+y_{bin})>>1

As the shifts in the assignments to x and y are left shifts, 3 LSBs in xbin and 2 in ybin are set to zero. When x and y are added there are 2 LSBs in the adder output, xbin+ybin, that are set to zero and following the assignment to z there is 1 LSB in zbin that is set to zero.

Thus, the FWLs of x and y can be reduced by 2. This is the minimum of the number of zero filled LSBs in x and y. The changes in FWL for x and y must be the same so that the two variables are still aligned after optimisation.

The result is that the shift in the assignment to y is eliminated, the shift in the assignment to x is reduced and the shift in the assignment to z is altered.
x_{bin}=a_{bin}<<1
y_{bin}=b_{bin}
z_{bin}=(x_{bin}+y_{bin})<<1

The following example illustrates a multiplication operation.
x_{bin}=a_{bin}<<3
y_{bin}=b_{bin}<<2
z_{bin}=x_{bin}*y_{bin}

Again there are 3 LSBs in xbin and 2 in ybin that are set to zero. When these variables are multiplied there are 5 LSBs in zbin that are set to zero. The FWL for x can be reduced by 3 and the FWL of y can be reduced by 2. The result is that the shifts in the assignments to x and y are eliminated and a new shift is introduced in the assignment to z.
x_{bin}=a_{bin}
y_{bin}=b_{bin}
z_{bin}=(x_{bin}*y_{bin})<<5

This optimisation step is implemented as follows. If a variable x is written to in an assignment that involves a left shift, then x is given a value of zero filled LSBs equal to the left shift amount. If the assignment involves a right shift or no shift then the number of zero filled LSBs is zero. If x is then read by a multiplication operator its value of zero filled LSBs is left unchanged. If x is read by an addition operator along with another input y and alignment is not required then x and y are both given the minimum of the two zero filled LSB values.

If x and y are read by an addition operator that does require alignment then the zero filled LSB values for both variables are set to zero. If x is read by more than one operator then its zero filled LSB value is the minimum of the individual zero filled LSB values calculated by each operator. If x is read by a unary operator then any changes to the zero filled LSB value for the output must be passed on to x. This is done using the unary input pointer. When the FWL of x is reduced by its zero filled LSB value the shift in the assignment to x is reduced or eliminated. Other assignment shifts in the algorithm may also be reduced or eliminated as a result of the change in the FWL of x.

Referring now to FIG. 2 of the drawings, there is illustrated a block diagram of the process of the simulation tool according to the first embodiment. As explained above, the tool operates over several phases.

Prior to execution of these phases, the first step comprises transforming source code for a floating point application into source code for a fixed point application. This is accomplished by defining the floating point variables of the application as type AWLFixedPoint.

In the first embodiment, this step is followed by phase 1 of the process, which involves eliminating overflow errors.

Within the simulation tool, code for processing the assignment and addition operators for fixed point variables is overloaded to record unused MSB/LSB information for fixed point variable operations requiring alignment as explained above.

When the application program code is compiled and executed by the tool, the altered assignment and addition operator code monitors the read and write operations performed on fixed point objects and records their associated numbers of unused MSBs and unused LSBs. If the recorded value of unused MSBs is negative, overflow has occurred and the output of the simulation tool informs the user as to which variables overflowed and by how many bits each of these variables overflowed. The user can then increase the IWL of these variables by the corresponding overflow amount. The variables identified as being associated with overflow errors and as such corrected during this phase are thus optimised and as a result will not be altered by the remaining phases of the process.

Phase 2 of the process involves eliminating redundant MSBs by increasing the fractional word length (FWL) of the relevant variables in order to maximise signal-to-noise ratio (SNR) of the application. The program code as modified after phase 1 is again compiled and executed. The tool tracks and records the number of unused MSBs and unused LSBs associated with each object and produces information associated with variables having redundant MSBs. The IWL of the variables identified by the simulation tool as having redundant MSBs are then reduced accordingly, so increasing the FWL and thereby optimising the SNR of the application.

According to the first embodiment, phase 3 of the process involves eliminating redundant LSBs in order to minimise the number of scaling operations required during execution of the application. Again the program code is compiled and executed after the adjustments made to the variables during phase 2. As explained above, since unused LSBs are dependent only on the operations involved in the algorithm and not a large sample set of values, this phase of optimisation procedure requires one pass over the program code including only one pass of each loop and as such need not be a time consuming process.

In any case, the simulation tool identifies the number of redundant LSBs present in each fixed point variable. The IWLs of these variables are increased accordingly in order to decrease the number of scaling operations required to perform the application.

Referring now to FIG. 8 of the drawings, there is illustrated a block diagram of the process of the simulation tool according to the preferred embodiment, as illustrated in FIG. 8, where the process further comprises a fourth phase.

Phase 4 of the process involves eliminating zero filled LSBs in order to minimise the number of scaling operations required during execution of the application. Again the program code is compiled and executed after the adjustments made to the variables during phase 3.

In any case, the simulation tool identifies the number of zero filled LSBs present in each fixed point variable. The IWLs of these variables are increased accordingly in order to decrease the number of scaling operations required to perform the application.

It will be appreciated that the altering of the MSBs and LSBs of the variables may be carried out manually by the user, automatically by the simulation tool in response to the results provided after the previous phase of execution or by any other suitable means.

Referring now to table 1, there is provided by way of example a simple application comprising phases 1, 2 and 3, presented as pseudo code, suitable for optimisation according to a first embodiment of the present invention.

TABLE 1

AWLFixedPoint c,s,cw,sw,ccw,csw,scw,ssw
c.iwl(−1);
s.iwl(−1);
cw.iwl(−1);
sw.iwl(−1);
ccw.iwl(−1);
csw.iwl(−1);
scw.iwl(−1);
ssw.iwl(−1);
c=cos(−ω+ψ);
s=sin(−ω+ψ);
cw=cos(ω);
sw=sin(ω);
for (n=0; n<testn;n++)
{
ccw=c*cw;
csw=c*sw;
scw=s*cw;
ssw=s*sw;
c=ccw−ssw;
s=scw+csw;
fxcos[n] = c;
fxsin[n] = s;
}

Initially, source code for the floating point version of the application is transformed into the source code for the fixed point application by declaring floating point variables as AWLFixedPoint types as shown in Table 1. In order to assess the affect of optimisation, the application includes floating point arrays fxcos and fxsin. The difference between their contents when using floating point versions of the other variables and when using fixed point versions of the other variables provides a measure of signal to noise. However, it will be appreciated that in actual fixed point application code, these would probably be defined as arrays of fixed point variables.

For the example above, each fixed point variable is assigned an initial arbitrary IWL, for example, −1. The code is compiled and executed on the simulation tool as described above.

Phase one of the process is carried out in order to eliminate overflow errors. If overflow errors occur, the user is notified of which variables overflowed and by how much, as depicted in FIG. 3. In this example, variables c, s, cw, scw, and ccw overflowed and each variable overflowed by 1-bit. Using this information, the user (or the tool) can increase the IWL of these variables to eliminate the overflow errors possibly without further repetition of phase 1. In this example, the IWLs of these variables are increased by 1, thus eliminating overflow errors.

Once the program executes with no overflow errors, information detailing the unused MSBs for each variable is then produced as illustrated in FIG. 4. The IWLs of these variables are reduced by the corresponding number of redundant MSBs recorded. The program code is compiled and executed with the new IWLs. As such, the unused MSBs have been reduced to zero, resulting in a maximum SNR by comparison with the results produced by the floating point version of the program. In this example, the optimisation of reducing the unused MSBs to zero increased the SNR ratio by 4.8 dB.

When the simulation is repeated with the new IWLs, information detailing the unused LSBs for each variable is produced as illustrated in FIG. 5. The IWLs of the variables with unused LSBs are then increased according to the redundant LSB information, thus resulting in a reduction in the number of scaling operations required. As can be seen from FIG. 6, this phase resulted in a 50% reduction in the number of scaling operations without affecting the maximised SNR.

Referring now to table 2, there is provided by way of example a simple application comprising phases 1, 2, 3, and 4, presented as pseudo code, suitable for optimisation according to the preferred embodiment of the present invention.

TABLE 2

```
AWLFixedPoint u (16, 6),
      v (16, 6),
      w (16, 6),
      x (16, 6),
      y (16, 6),
      z (16, 6),
      p0(32, 6),
      p1(32, 6),
      p2(32, 6),
      t (32, 6),
      s (32, 6);
u = fu( );
v = fv( );
w = fw( );
x = fx( );
y = fy( );
z = fz( );
p0 = u * v;
p1 = w * x;
p2 = y * z;
t = p0 + p1;
s = t * p2;
```

The variables u, v, w, x, y and z are given a word length of 16. The variables p0, p1, p2, t and s are given word lengths of 32. All of the variables are given an initial IWL of 6. The variables u, v, w, x, y and z are assigned values from the functions fu( ), . . . , fz( ). These functions can return floating point or fixed point values.

Initially, source code for the floating point version of the application is transformed into the source code for the fixed point application by declaring floating point variables as AWLFixedPoint types as shown in Table 2.

For the example above, the variables u, v, w, x, y and z are given a word length of 16. The variables p0, p1, p2, t and s are given word lengths of 32. All of the variables are given an initial IWL of 6. The variables u, v, w, x, y and z are assigned values from the functions fu( ), . . . , fz( ). These functions can return floating point or fixed point values. The code is compiled and executed on the simulation tool as described above.

Phase one of the process is carried out in order to eliminate overflow errors. If overflow errors occur, the user is notified of which variables overflowed and by how much, as depicted in FIG. 7. In this example, variables p0, p2, t and s overflowed by 1-bit, 3-bits, 2-bits and 4-bits respectively.

Using this information, the user (or the tool) can increase the IWL of these variables to eliminate the overflow errors possibly without further repetition of phase 1. In this example, the IWLs of these variables are increased by the amount they each overflowed by, thus eliminating overflow errors.

Once the program executes with no overflow errors, information detailing the unused MSBs for each variable is then produced as illustrated in FIG. 8. The IWLs of these variables are reduced by the corresponding number of redundant MSBs recorded.

In this example the number of scaling operations is described for barrel shifters and 1-bit shifters. A barrel shifter can perform a shift by any amount in 1-cycle. A 1-bit shifter can perform a shift by N places in N cycles.

With these IWLs the algorithm involves the following scaling operations:
p0=(u*v)<<2
p1=(w*x)<<3
p2=(y*z)<<3
t=(p0+(p1>>1))>>1
s=((t>>1)+p2)>>1

The program code is compiled and executed with the new IWLs. As such, the unused MSBs have been reduced to zero, resulting in a maximum SNR by comparison with the results produced by the floating point version of the program. In this example, the optimisation of reducing the unused MSBs to zero increased the SNR ratio by 18.6 dB.

When the simulation is repeated with the new IWLs, information detailing the unused LSBs for each variable is produced as illustrated in FIG. 9. The IWLs of p1 and t are increased by 1-bit according to the redundant LSB information produced in phase 3. The scaling operations become:
p0=(u*v)<<2
p1=(w*x)<<2
p2=(y*z)<<3
t=(p0+p1)>>2
s=(t+p2)>>1
thereby resulting in a reduction in the number of scaling operations required, as can be seen from FIG. 10, without affecting the maximised SNR.

Using this information, the IWLs of p0, p1 and p2 are increased accordingly. The scaling operations for the final algorithm are:
p0=u*v
p1=w*x
p2=(y*z)<<3
t=p0+p1
s=(t+p2)>>1
and the number of scaling operations is reduced to 2 barrel shifts and 4 1-bit shifts. Again the signal-to-noise ratio is unaffected and the overall number of scaling operations has been further reduced.

The present invention is not limited to the embodiments described herein, which may be amended or modified without departing from the scope of the present invention.

1. A method for optimising application program code including a plurality of fixed point variables, each fixed point variable comprising a binary pattern having an integer portion having an integer word length (IWL) and a fractional portion having a fractional word length (FWL), the method comprising the steps of:
first simulating execution of said application to identify any variables to which values having a greater IWL are assigned and first modifying said application program code to increase the IWL of those variables by an amount required to prevent overflow errors;
second simulating execution of said first modified application program code to identify any redundant bits of said integer portions associated with each variable and second modifying said application program code to reduce the IWL of those variables to remove said redundancy; and
third simulating execution of said second modified application program code to identify any redundant bits of said fractional portions associated with each variable and third modifying said application program code to increase the IWL of those variables by an amount required to remove said redundancy.

2. The method according to claim 1 further comprising the step of:
fourth simulating execution of said third modified application program code to identify any redundant zero filled bits of said fractional portions associated with each variable and fourth modifying said application program code to increase the IWL of those variables by an amount required to remove said redundancy.

3. A method as claimed in claim 1 comprising:
transforming application program code including a plurality of floating point variables to replace said floating point variables with respective fixed point variables.

4. A method as claimed in claim 1 wherein the combined integer and fractional word lengths for all fixed point variables is set in common according to the platform on which said application is to be deployed.

5. A method as claimed in claim 1 wherein the combined integer and fractional word lengths for each fixed point variables is user defined.

6. A simulation tool arranged to perform the steps of claim 1.

7. The simulation tool according to claim 6 in which said tool is arranged to maintain during each of said simulating steps for each fixed point variable respective indicators of the number of redundant bits in each of the integer and fractional portions of said fixed point variable.

8. The simulation tool according to claim 7 in which after simulating, a negative value of said redundant integer portion indicator indicates that an overflow error has occurred for said fixed point variable.

9. The simulation tool according to claim 7 in which assignment operator code for fixed point variables is arranged to update said indicators.

10. The simulation tool according to claim 7 in which assignment operator code and code for binary operators requiring alignment of source operands is arranged to track whether an alignment of fixed point variable operands is required to perform an operation.
